(19) United States
(12) Patent Application Publication
(10) Pub. No.: US 2018/0170195 A1
(43) Pub. Date: Jun. 21, 2018

(54) EVSE OUTPUT PORT MULTIPLIER RETROFIT

(71) Applicant: Schneider Electric USA, Inc., Andover, MA (US)

(72) Inventors: Kevin M. Jefferies, Raleigh, NC (US); Benjamin W. Edwards, Rolesville, NC (US); Matthew L. White, Cary, NC (US); Konstantin Alexander Filippenko, Grenoble (FR); Richard Karl Weiler, Wake Forest, NC (US)

(73) Assignee: Schneider Electric USA, Inc., Andover, MA (US)

(21) Appl. No.: 15/383,760

(22) Filed: Dec. 19, 2016

(51) Int. Cl. B60L 11/18; H02J 7/00; H01R 24/78

(52) U.S. Cl. CPC B60L 11/1818; H02J 7/007; H01R 2103/00; H01R 24/78; H02J 2007/0096; H02J 7/0021

(57) ABSTRACT

A multiple output port adapter retrofit is used to extend the number of output ports for a single port Electric Vehicle Supply Equipment (EVSE) in a cost efficient manner without affecting the single EVSE supply power infrastructure. Each branch of the adapter has a self-contained controller and communicates with other branches via a central communication bus. The branch central controllers evenly divide the available power capacity and allow simultaneous charging of multiple EVs with the divided power and without adding requirements to the Electric Vehicle Supply Equipment.

### BACKGROUND OF THE INVENTION

### 1. Field of the Invention

The present invention relates to Electric Vehicle Supply Equipment (EVSE) charging of Electric Vehicles (EVs). More particularly the present invention relates to retrofitting of a single port EVSE to a multiple port EVSE allowing simultaneous charging without the need for changing the existing EVSE power infrastructure.

### 2. Discussion of the Related Art

With the growth of Electric Vehicle (EV) popularity new infrastructure is constantly needed to charge the vehicles. In EVSE charging the Electric Vehicle adjusts its battery management system in response to the Control Pilot Signal. Maximum charging power is limited in the SAE J1772 protocol by the J1772 Control Pilot Signal and the battery management system charges the battery with the battery's safe operating envelope limited by the Control Pilot Signal.

A majority of Electric Vehicle charging is residential charging which happens at a driver's home where there may be one charger, typically with a single EV port, i.e. connector. Other charging is considered “opportunity” charging, i.e. charging in public spaces such as parking lots at shopping centers, in city centers, and at work places. Charging infrastructure involves at least two aspects, installation of EVSEs, and installation of the power distribution for the EVSEs.

Thus there is anticipated to be a large installed base of single cable EVSEs. Many of these personal EVSEs are relatively simple one cable distribution units, often without current measuring/monitoring capabilities. In some cases there may be a dual cable unit which is considered to be two single cable units in the case where the power control of each cable does not interact, within the meaning of the present disclosure. As personal owners add EVs to their fleet it is highly likely that most multiple EV owners will wish to expand their ability to simultaneously charge a plurality of EVs. Likewise, opportunity charging facilities will need to expand the number of ports available to customers without significant infrastructure investment. Thus it would be desirable to provide an economical alternative to the replacement of the existing EVSE, and obtain another charging cable for simultaneous charging of multiple EVs without the major costs of infrastructure improvement to the power delivery grid or total replacement of the installed EVSE or both. Heretofore the known art is believed to have concentrated its efforts on multiple EVSEs and complicated energy management systems for multiple EVSEs based on central controllers for the distribution from multiple outlets and the current consumption monitoring of each port.

For a significant portion of opportunity charging EVSE installations, the total power capacity is already set based on the originally installed EVSE charging system. With the continued adoption of EVs, the need will increase for a solution to allow simultaneous charging of more vehicles, with minimum impact on the installation infrastructure. Thus, it would be desirable to increase the available charging ports of a single port EVSE installation without requiring an increased power capacity, and without requiring modification of the installed infrastructure upstream of the EVSEs or expensive internal upgrades to the EVSE unit itself.

Applicants have heretofore proposed in U.S. application Ser. No. 15/279,567 [RLC-0168] some methods and apparatus for energy management systems of EVSEs including a retrofit collar for turning each EVSE port into a smart apparatus which can cooperate with other EVSEs. However, there is still clearly a need for more economical retrofits for single port EVSEs to enable increased port capacity with simultaneous EV charging within the known art.

### SUMMARY OF THE INVENTION

The present invention provides an increase in available charging ports for a single port existing EVSE installation, allowing simultaneous charging of multiple EVs, with a minimal impact on the installation infrastructure, and with no requirement for increased power capacity. In practice, most EVs charge at either their maximum rate, or the charge rate offered by the EVSE for the majority of charging, whichever is less. Aspects of the present invention are designed to take advantage of this relative simplicity of charging operations.

To this end, aspects of the present invention provide an EVSE retrofit as an extender for a single EVSE port which can retrofit a single port EVSE to create multiple output branches, with decentralized control, each branch containing its own control electronics and operating a simple algorithm and checking the requests and connections of the other branches to evenly divide the available power and issue a new Control Pilot Signal to the connected Electric Vehicles. Based on the connection status of the total charging outputs within the EVSE unit, the control electronics modifies the pilot signal pulse width modulated (PWM) output to the connected EV to offer a charging rate that allows sharing the capacity of the original EVSE. Because the invention is illustrated with the SAE J1772 protocol as an example the terms “control pilot signal” and “charge rate offer signal” and “offer signal” will be used interchangeably in the explanation. The new Control Pilot Signal can be dynamically adjusted based on the changing number of actively charged vehicles with closed contactors.

The invention incorporates into the EVSE retrofit system standard EVSE functional blocks with the addition of a connection between multiple instances of the control electronics functional blocks. That is, the independent control electronics of the individual branches communicate through a central communications bus to obtain the status of the other branches.

Some aspects of the present invention may provide a retrofit for an EVSE location which can be retrofit as an extender to the original EVSE power supply for multiple Electric Vehicles to divide and distribute available power, comprising one or more modules creating a branch of equal power handling capacity to that of the original EVSE and which connect to the original single port EVSE supply power, each retrofit branch having: an input portion for accepting the original EVSE supply power to create multiple output ports for fitting to a plurality of standard Electric Vehicle receptacles. Each branch will have independent control electronics to manage EVSE-to-Electric Vehicle connection protocol according to an industry standard. Each branch will further have a Ground Fault Interrupter (GFI) and an in-line switch for opening and closing the circuit of the branch conductors.

Functional blocks of the independent control electronics for each branch may include a controller for processing and sharing information among the branches, a control pilot signal (CPS) generator module to generate the new offer signal and send the new offer signal to the Electric Vehicles, according to division and delivery algorithms implemented at each branch, and with or without knowledge of present actual EV current consumption; a communication module and bus for sharing information between the branches; a proximity measurement module to determine if the EVSE port is attached to an EV; and an optional current measurement module to measure how much current the Electric Vehicle is drawing and maximize the utilization of available EVSE capacity with each new charge rate offer.

In other aspects the present invention can include an EVSE retrofit for increasing the number of output ports from a single port EVSE allowing simultaneous charging without an increase in electrical capacity, comprising:

the retrofit having a plurality of branch modules with an input for accepting original ground and powerlines from the original EVSE supply power and providing multiple output ports for connection to EVs;
each of the plural branches having a line switch for opening and closing the respective powerlines, a ground fault interrupter, and a control electronics unit, and
the control electronics unit having an individual controller running an identical algorithm without the need for current consumption measurement to determine a distribution of the original EVSE power capacity to active ones of the plural branches connected to an EV and without exceeding an original power capacity of the single charging unit.

In other aspects of the invention a method of controlling power from an Electric Vehicle Supply Equipment to an Electric Vehicle includes an algorithm contained in hardware, firmware, volatile or nonvolatile memory, of the branch control electronics, for the adjustment of the offer rate at each output port including the steps of: determining a charge rate offer update is needed;

determining if there is a change in the number of EVs requesting a charge, determining if the contactor of each requesting branch is closed and, if YES, set charge rate offers at each port to evenly divide EVSE capacity to the EVs connected, requesting charge, and having contactor closed; and, if NO, returning to a state for determining an offer update

An EVSE retrofit of the present invention may further comprise a power delivery algorithm for controlling power delivery to an EV, the delivery algorithm including the steps of: detect EV connection on branch;

set PWM duty cycle for branch output by dividing EVSE capacity by number of charge requests from connected EVs, and output a corresponding PWM control pilot signal;
receive EV request for a charge;
command branch line switch closure;
output signal “EV connected to this cable and charging” from control electronics;
receive EV request to stop charge;
command line switch opening;
lower signal output (set signal low) to other control electronics to set flag “EV connected to this cable is not charging;”
check flags for “EV connected to other cable and charging;” and
check if other contactor closed, if YES, set duty cycle by division, if NO retain current offerings.

In all aspects of the present invention there is no central controller required among the multiple retrofit branches.

### BRIEF DESCRIPTION OF THE DRAWINGS

The foregoing and other advantages of the disclosed embodiments will become apparent upon reading the following detailed description and upon reference to the drawings, wherein:

FIG. 1 is a schematic representation of an EVSE retrofit system, according to aspects of the present invention, with the addition of multiple output ports, each having interconnected control electronics and an output port.

FIG. 2 is a schematic of exemplary functional blocks for the interconnected control electronics for each branch of the EVSE

FIG. 3 is a flow chart of a power delivery algorithm for the multiple ports during simultaneous charging.

FIG. 4 is a flow chart of a power division algorithm for the multiple ports during simultaneous charging.

FIG. 5 is a flow chart for an alternative embodiment of the power division algorithm which can utilize current consumption measurement to further increase total EVSE capacity utilization.

### DETAILED DESCRIPTION

As an initial matter, it will be appreciated that the development of an actual commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

It should also be understood that the embodiments disclosed and taught herein are susceptible to numerous and various modifications and alternative forms. Thus, the use of a singular term, such as, but not limited to, “a” and the like, is not intended as limiting of the number of items. Similarly, any relational terms, such as, but not limited to, “top,” “bottom,” “left,” “right,” “upper,” “lower,” “down,” “up,” “side,” and the like, used in the written description are for clarity in specific reference to the drawings and are not intended to limit the scope of the invention.

The illustrated embodiment can be considered an overlay on a standard Electric Vehicle charging and connector system so it operates with every model of EVSE using that standard. It will of course be appreciated by the person of ordinary skill in the art that the invention is not limited to use with the SAE J1772 standard.

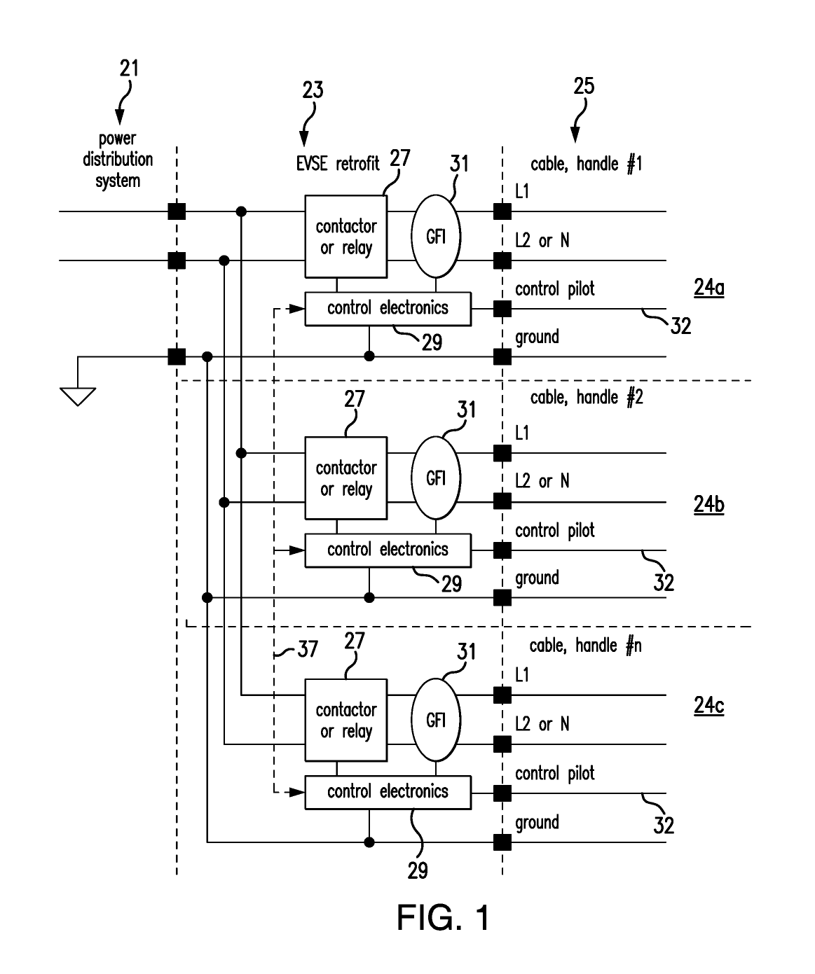

FIG. 1 shows aspects of the present invention including the power distribution system 21, such as from the regular AC supply grid, for an originally placed Electric Vehicle Supply Equipment (EVSE) unit (not shown) which has been supplanted by a retrofit 23 to provide a plurality of similarly equipped branches, e.g. the three shown, collectively 25, with each branch 24a, 24b, 24c providing hardware for a connection port with a cord and connector handle (not shown) which could, for example be of the SAE J1772 standard type if located in the USA, for connection to an EV (not shown). The branch hardware of the retrofit 23 could be individually housed modules or it is envisioned that the modules would preferably be supplied as multiple assemblies within a single prefabricated housing. The power distribution system 21 of the EVSE retains the original line power (L1, and L2 or N) conductors and the ground line. Each branch 24a, 24b, 24c of the retrofit 23 is connected to the two line power and ground lines and continues with its own branch power and ground lines. Each branch 24a, 24b, 24c further has its own line switch 27, e.g. contactor or relay, across the power lines, as well as control electronics 29 and a ground fault interrupter (GFI) 31. The switch 27 and GFI 31 are both connected to the control electronics 29. Each control electronics unit 29 also outputs its branch control pilot signal on a signal line 32 through its respective output port 25 along with the accompanying power and ground lines.

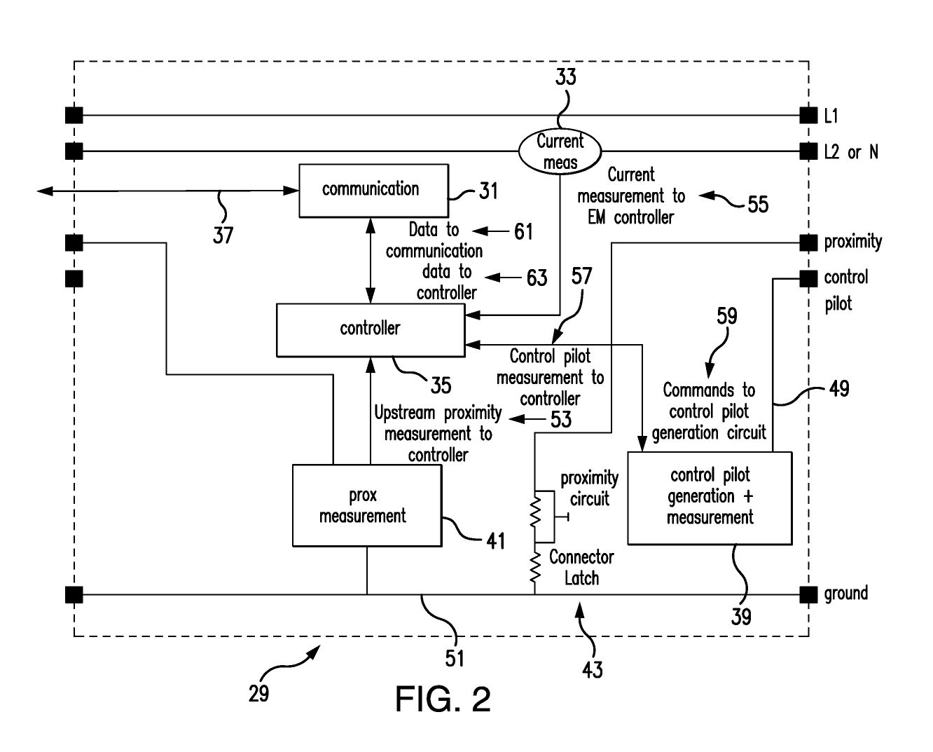

FIG. 2 illustrates functional blocks within the control electronics 29 of each branch of the retrofit 23. It will be appreciated that the modules and blocks of the electronics are designated functionally and may of course be arranged in a variety of layouts. The electronics in some aspects or embodiments of the invention may include: a current measurement module 33 provided on one of the energy carrying lines (here L2) to measure how much current the Electric Vehicle is drawing, although it will be appreciated that a current consumption measurement is not required for operation of all embodiments.

Also included is a Controller 35 as a processor module provided for processing the data within the retrofit and the output of control signals; and creating instructions for a new Control Pilot Signal generation sent to a control pilot signal generator 39 to generate and send a new Control Pilot Signal to a connected Electric Vehicle for charging control/negotiation.

Also included is an proximity measurement module 41 provided to determine the EVSE handle is attached to an EV. A proximity circuit and a connector latch 43 are provided to generate a proximity signal from the retrofit to the Electric Vehicle, and to establish a ground connection for the retrofit and maintain the ground connection throughout the vehicle charging circuit.

As stated, the Controller 35 issues commands to manipulate the branch control pilot signal in accordance with a charging standard (such as a J1772 interface), such as by requesting a charge from the upstream EVSE port by connecting a specific resistance between the control pilot line 49 and ground 51, i.e. the same pilot signal is used to request power from the EVSE port after it's analog level is modified by the Electric Vehicle and repeated back through the EVSE.

Other signals may include a Proximity measurement signal 53 sent to the Controller 35. This signal tells the Controller 35 the state of the proximity circuit on the EVSE handle, in accordance with the standard interface, such as if the proximity switch is pressed and that the EVSE is well connected to the adapter. A Current measurement signal 55, if included, is sent to the Controller 35 to tell the Controller 35 the value of charging current drawn by the Electric Vehicle. A Control pilot measurement 57 is sent to report to the Controller 35 the state of the control pilot signal, in accordance with the standard interface, including if the connected Electric Vehicle is requesting charging current.

Commands to the control pilot generation circuit 59 are sent when the Controller 35 issues commands to tell the control pilot generation circuit 39 what output to generate, such as the state of the control pilot signal and the duty cycle of the control pilot pulse width modulated (PWM) signal, for example, as in accordance with the standard J1772 interface, and to open the line switch 27 to charge the EV in accordance with the calculated charging rate.

Data signals 61 are issued out to the communication module 31 by the Controller 35 which can send connection data along the communication bus 37 to each of the other branch controllers, including the status of the output port (e.g., charging, not charging), state of the branch line switch (contactor) 27, and, in some embodiments, data such as current measurement and the charge rate being offered to the Electric Vehicle by the branch.

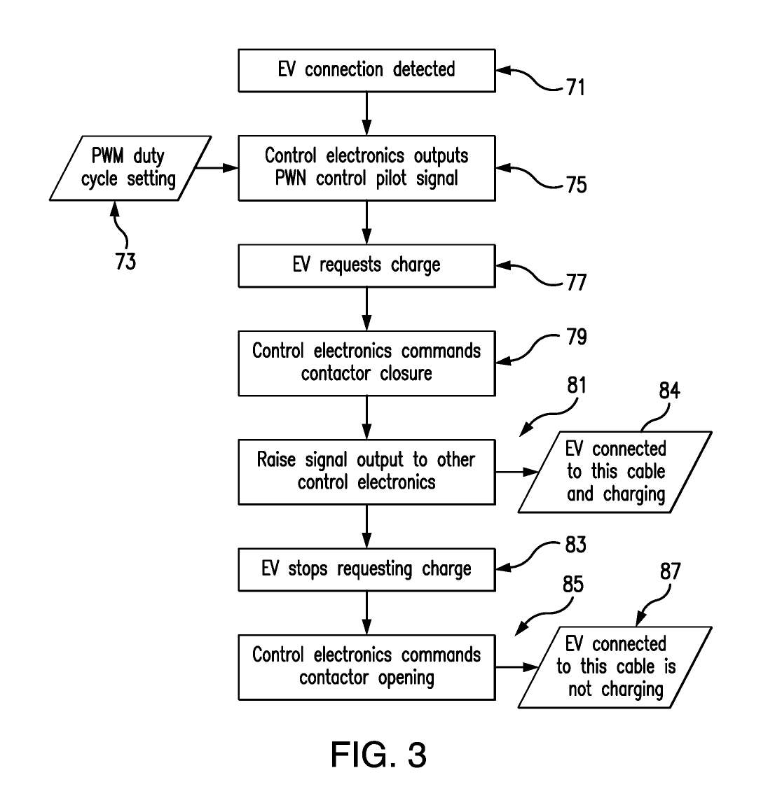

As seen in FIG. 3 the delivery algorithm flow chart starts with an EV connection to a one retrofit output port 24a, 24b, 24c, being detected at 71. The duty cycle for charging power is set at 73 according to simple division or a division algorithm based on current consumption as further discussed below, and the Control Pilot Signal is constructed and output to the EV at 75. If the charge offer is acceptable to the EV, a charge request is established at 77 and when the request is recognized by the controller 35 it issues a command to close the line switch 27 (labeled here as a contactor) at 79. Closing the line switch 27 allows power to flow to the EV and also causes the generation of a “this branch is connected and charging” signal 84 to be output at 81 on the communications bus 37 for availability to the other branch controller electronics 29. When the charging is completed, an “EV stops requesting charge” signal is generated at 83, the Control electronics unit 29 commands the opening of the line switch 27 and a “EV connected to this cable is not charging” signal is generated at 87 until the handle is disconnected.

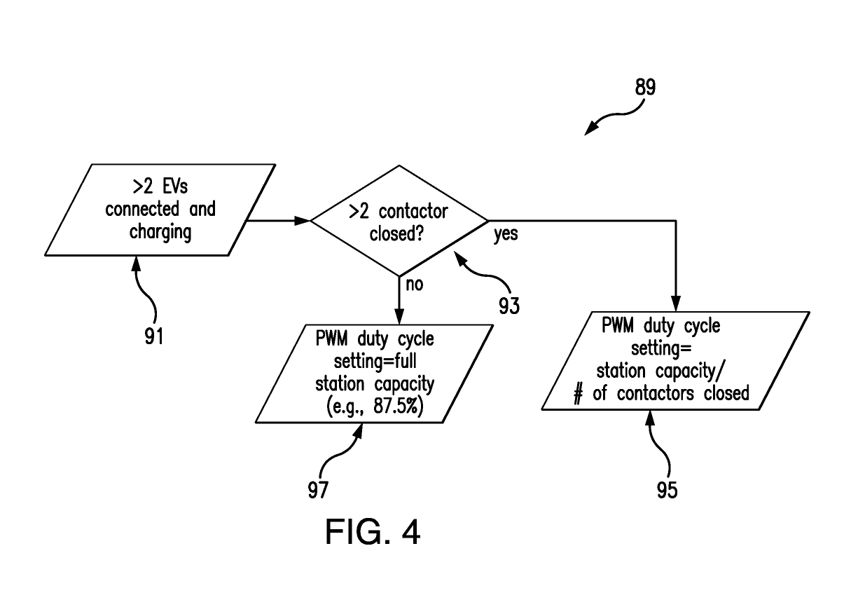

As seen in FIG. 4, a simple charge offer division algorithm 89 used by the branch control electronics 29 can be based on the number of branches reporting “EVs connected and charging” at 91. The remaining branches are polled at 93 to determine if any other line switches 27 are closed. If YES, the PWM duty cycle is set to the total available power of the station capacity at 95 divided by the number of line switches (e.g. contactors) which are closed. If NO, the PWM duty cycle is set to full station capacity at 97.

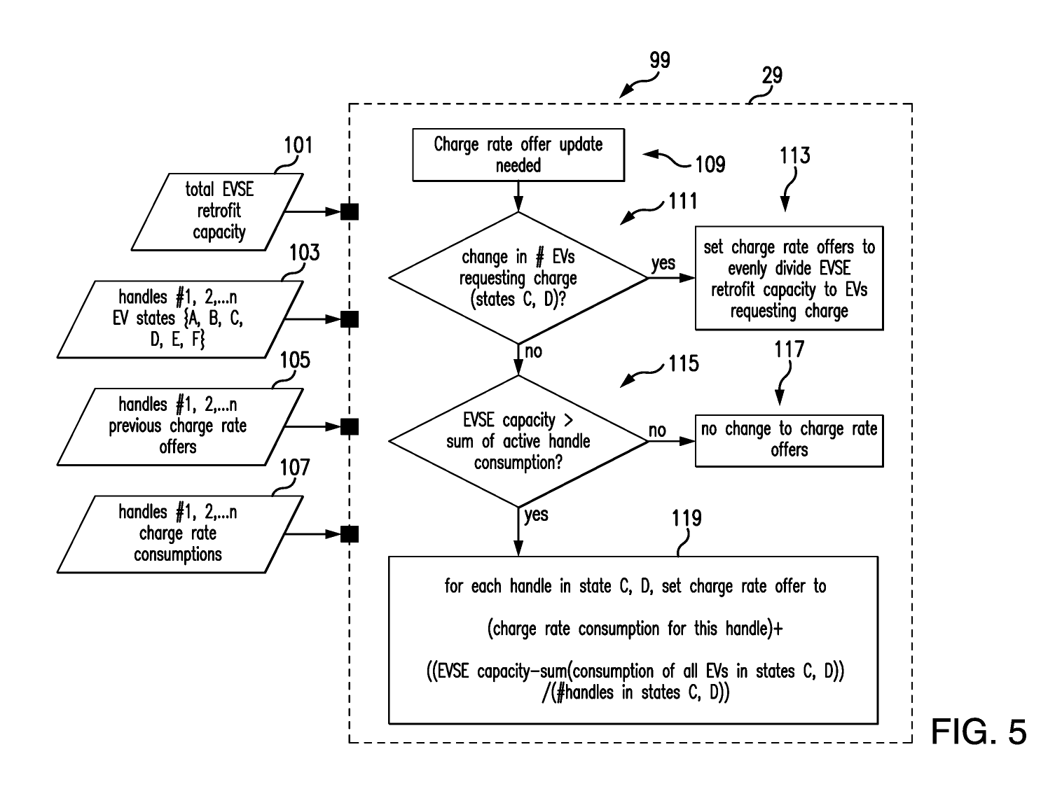

As seen in FIG. 5, a second type algorithm 99 can be implemented to maximize the use of station capacity over and above a simple division among the number of ports that are charging, as EV requests change (e.g. one may be lowered as charging gets nearly completed), by inputting total EVSE retrofit capacity 101, i.e. total power available from the EVSE, the status of each charging port (e.g. states A, B, C, D, E, or F, as defined by J1772) at 103, the previous charge rate offers of the charging ports at 105, and the present charge rate consumptions of each port at 107, into the control electronics 29. To determine the distribution of excess capacity, if any, first a change rate offer update need is identified at 109, and it is determined at 111 whether this indicates a change in the number of ports requesting a charge. If YES then the charge rate offers can be set according to an even division of retrofit (EVSE) capacity among the requesting ports at 113, or if NO (no change in the number of EVs requesting) the EVSE capacity is compared against the sum of the active port (handle) consumption at 115. If capacity is not greater than consumption then no change is made to the charge rate offers, as at 117. If capacity of the EVSE is greater than present consumption at the EVSE, then a change is made to the charge rate offers, as at 119, for each output port handle in states C or D (reference J1772 states, i.e. EV is connected and ready to accept charge without or with required ventilation) whereby the charge rate offer is set to: the sum of charge rate consumption for this handle plus (the total EVSE capacity minus (the sum of the present consumption of all EVs connected and ready to accept charge divided by the number of handles connected and ready to accept charge); in order to distribute the presently unutilized charging capacity of the EVSE among the branches.

Thus has been presented a retrofit for an EVSE to increase the number of output ports for simultaneous EV charging with minimal to no effect on the existing power supply structure. The retrofit is shown as having an input port for accepting ground and powerlines from the original power distribution system of the original EVSE and an extender to plural branches providing multiple output cables for connection to a plurality of EVs. Each of the plural branches is shown having an individual controller running the same power division algorithm and operating independently in each control electronics unit to evaluate the capacity available within the EVSE, with or without the need for current consumption measurement, to determine a distribution or redistribution of the original EVSE total capacity among the branches; whereby each branch can be internally managed to determine the appropriate PWM duty cycle and output power percentage, accordingly, to prevent exceeding the capacity of the single port charging unit being replaced.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the invention as defined in the appended claims.

1. An EVSE retrofit for increasing the number of output ports from a single port EVSE allowing simultaneous charging without an increase in electrical capacity, comprising:
the retrofit having a plurality of branch modules with an input for accepting original ground and powerlines from the original EVSE supply power and providing multiple output ports for connection to EVs;
each of the plural branches having a line switch for opening and closing the respective powerlines, a ground fault interrupter, and a control electronics unit, and
the control electronics unit having an individual controller running an identical algorithm without the need for current consumption measurement to determine a distribution of the original EVSE power capacity to active ones of the plural branches connected to an EV and without exceeding an original power capacity of the single charging unit.

2. The EVSE retrofit of claim 1 wherein each branch control electronics unit is connected on a communication bus with the other branches.

3. The EVSE retrofit of claim 2 wherein each branch announces only its EV connection and charging state information on the communications bus.

4. The EVSE retrofit of claim 2 wherein each branch announces only its charge request and line switch states information on the communications bus.

5. The EVSE retrofit of claim 1 wherein the line switch is one of a contactor or a relay.

6. The EVSE retrofit of claim 1 wherein there is no central coordinator between the control electronics of each branch.

7. The EVSE retrofit of claim 1 wherein the identical algorithm is a division algorithm which contains the steps of:
determining a charge rate offer update is needed;
determining if there is a change in the number of EVs requesting a charge,
determining if the contactor of each requesting branch is closed and, if YES, set charge rate offers at each port to evenly divide EVSE capacity to the EVs connected, requesting charge, and having contactor closed;
and, if NO, returning to a state for determining an offer update.

8. The EVSE retrofit of claim 1 wherein the identical algorithm contains the steps of:
determining a charge rate offer update is needed;
determining a present measurement of current consumption;
determining if present current consumption is less than EVSE power capacity, and
if YES, then for each output port connected to and charging an EV, set charge offer to (charge rate consumption for this branch)+((EVSE capacity−sum (consumption of all EVs connected and charging))/(divided by) the number of ports connected and charging).

9. The EVSE retrofit of claim 1, further comprising a power delivery algorithm for controlling power delivery to an EV, the delivery algorithm including the steps of:
a) detect EV connection on branch;
b) set PWM duty cycle for branch output by dividing EVSE capacity by number of charge requests from connected EVs, and output a corresponding PWM control pilot signal;
c) receive EV request for a charge;
d) command branch line switch closure;
e) output signal “EV connected to this cable and charging” from control electronics;
f) receive EV request to stop charge;
g) command line switch opening;
h) lower signal output (set signal low) to other control electronics to set flag “EV connected to this cable is not charging;”
i) check flags for “EV connected to other cable and charging;” and
j) check if other contactors closed, if YES, set duty cycle by division, if NO retain current offerings.
